(19) United States
(12) Patent Application Publication
(10) Pub. No.: US 2023/0230753 A1
(43) Pub. Date: Jul. 20, 2023

(54) ELECTRONIC COMPONENT AND METHODS RELATING TO SAME

(71) Applicant: Coilcraft, Incorporated, Cary, IL (US)

(72) Inventors: Andrew Klesyk, Lake in the Hills, IL (US); Lawrence B. Lestarge, Algonquin, IL (US); Scott Hess, Crystal Lake, IL (US); Matt Goedken, Gurnee, IL (US)

(21) Appl. No.: 18/097,104

(22) Filed: Jan. 13, 2023

Related U.S. Application Data
(60) Provisional application No. 63/299,525, filed on Jan. 14, 2022.

(51) Int. Cl. H01F 27/29; H01F 27/28; H01F 17/04; H01F 41/02

(52) U.S. Cl. CPC H01F 27/292; H01F 27/2823; H01F 17/045; H01F 41/0246; H01F 2017/046; H01F 2017/048

(57) ABSTRACT

An electronic component, such as, for example, an inductor, includes a core defining an axis and a conductor that is at least partially wound about the core. The electronic component further includes a mounting surface defining a plane that extends substantially parallel to the axis of the core. The mounting surface is configured to engage a surface of a board. The conductor may include a first terminal and a second terminal extending along the plane such that the first and second terminals are able to be mounted to the surface of the board.

### CROSS-REFERENCE TO RELATED APPLICATIONS

This application claims the benefit of U.S. Provisional Application No. 63/299,525, filed Jan. 14, 2022, and is incorporated herein by reference in its entirety.

### FIELD OF THE INVENTION

This disclosure generally relates to electronic components such as inductors and, more particularly, to the winding configuration and orientation of a conductor around a core, and methods relating to same.

### BACKGROUND

The electronics industry is continually called upon to make products smaller and more powerful. Applications such as mobile phones, portable computers, computer accessories, hand-held electronics, etc., create a large demand for smaller electrical components. These applications further drive technology and promote the research of new areas and ideas with respect to miniaturizing electronics. The technology is often limited due to the inability to make certain components smaller, faster, and more powerful.

Magnetic components, such as inductors, are examples of the type of components that have been forced to become smaller and/or more powerful. Typical inductors often comprise a wire wound or coiled about a core of magnetic material, such as ferrite, with the ends of the wire forming respective terminals for mounting the component into an electronic circuit of some type, usually on a printed circuit board. The core and the coil each occupy substantial space both in height and surface footprint. Typically, as the induction and power handling of an inductor increases or otherwise improves, the footprint and/or the height of the inductor also increases, often beyond the allowable space allocated for such an inductor within the form factor of an electronic device utilizing the inductor. However, as electronic devices, such as mobile telephones, smart phones, PDAs, and other portable electronic devices, become smaller, less space is allowed for such inductors while at the same time the performance required by such inductors often increases.

Accordingly, it has been determined that the need exists for an improved inductor component and method for manufacturing the same which overcomes the aforementioned limitations, and which further provide capabilities, features and functions, not available in current devices and methods for manufacturing.

### BRIEF DESCRIPTION OF THE DRAWINGS

FIG. 1A is a bottom perspective view of an electronic component according to a first embodiment;

FIG. 1B is a bottom perspective view of the electronic component of FIG. 1A with an outer body shown as see through for illustrative purposes;

FIG. 1C is a top perspective view of the electronic component of FIG. 1A shown without the outer body;

FIG. 1D is a bottom perspective view of the electronic component of FIG. 1A shown without the outer body;

FIG. 1E is a front elevational view of the electronic component of FIG. 1A shown without the outer body;

FIG. 2A is a bottom perspective view of an electronic component according to a second embodiment with the outer body shown as see through for illustrative purposes;

FIG. 2B is a bottom plan view of the electronic component of FIG. 2A with the outer body shown as see through for illustrative purposes;

FIG. 2C is a bottom perspective view of a conductor of the electronic component of FIG. 1A;

FIG. 2D is a front elevational view of the conductor of FIG. 2C;

FIG. 2E is a top plan view of the conductor of FIG. 2C;

FIG. 3A is a bottom perspective view of an electronic component according to a third embodiment with the outer body shown as see through for illustrative purposes;

FIG. 3B is a bottom perspective view of a conductor of the electronic component of FIG. 3A;

FIG. 3C is a top plan view of the conductor of FIG. 3B;

FIG. 3D is a bottom plan view of the conductor of FIG. 3B;

FIG. 4A is a bottom perspective view of a conductor of an electronic component according to a fourth embodiment;

FIG. 4B is a top plan view of the conductor of FIG. 4A;

FIG. 4C is a bottom plan view of the conductor of FIG. 4A;

FIG. 5A is a bottom perspective view of a conductor of an electronic component according to a fifth embodiment;

FIG. 5B is a top plan view of the conductor of FIG. 5A; and

FIG. 5C is a bottom plan view of the conductor of FIG. 5A.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an electronic component, such as an inductor, comprises a core having a conductor wound around at least a portion of the core to form at least a partial turn/winding, or a number of turns/windings. The core may be elongate and extend horizontally or parallel to the surface to which the electronic component is mounted. The electronic component may further include terminals connected to or formed by the each of the ends of the conductor for electrically coupling the electronic component into at least one circuit (e.g., a printed circuit board).

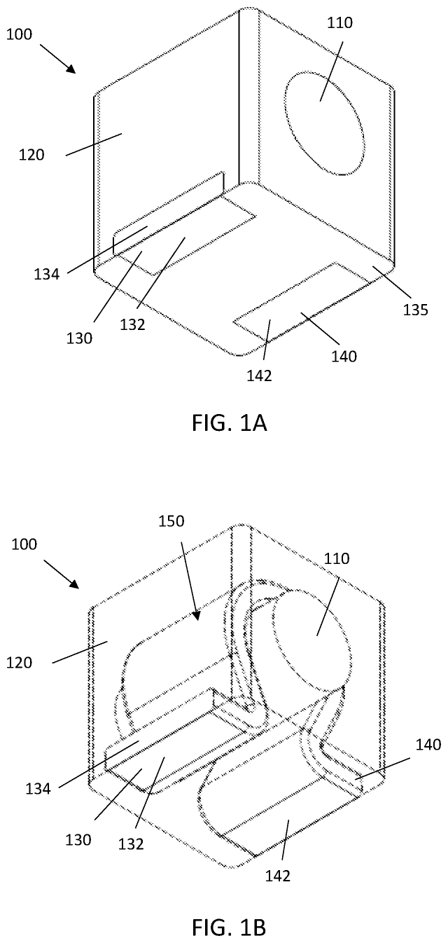

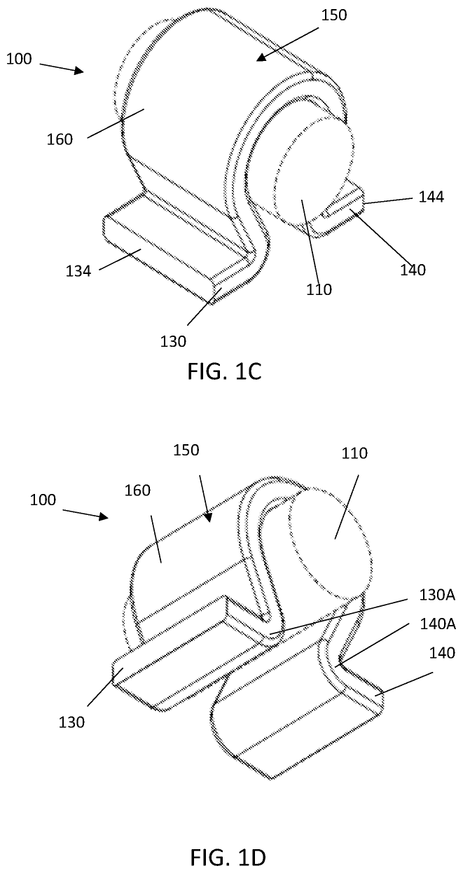

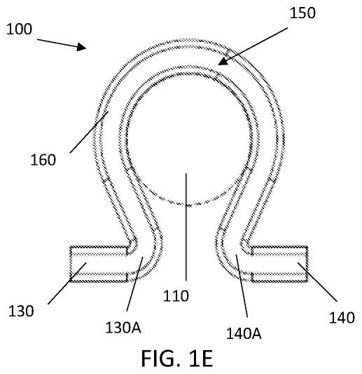

Referring now to the drawings, and in particular FIGS. 1A-1E, an electronic component 100 is illustrated in accordance with one embodiment. The electronic component 100 includes a core 110 and a conductor 150. The core 110 may be formed of a ferrite material, although a number of other conventional materials may be used. The component 100 may further include an outer body 120 disposed about at least a portion of the core 110 and the conductor 150.

The component 100 may further include two terminals, a first terminal 130 and a second terminal 140. In the embodiment shown, the first terminal 130 and the second terminal 140 are formed by the end portions of the conductor 150. In other embodiments, the first terminal 130 and second terminal 140 may be clips to which the ends of the conductor 150 are electrically coupled. For example, a clip may be mounted to the side of the component 100 in electrical contact with an end portion of the conductor. The clip may have a conductive plate that provides a surface that can be soldered to in order to mount the component, e.g., to a circuit board. The first terminal 130 and second terminal 140 are configured for mounting and mechanically coupling the electronic component 100 to a mounting surface, such as a surface of a circuit board, and to electrically couple the electronic component to a circuit. The first terminal 130 and the second terminal 140 may be flush with a bottom surface 135 of the electronic component 100 or extend within a plane that is substantially parallel to the mounting or bottom surface 135 of the electronic component 100. The terminals 130, 140 may thus extend within a plane for mounting the electronic component 100 to a substantially flat mounting surface that is substantially parallel to bottom surface of the electronic component 100 and/or plane in which the terminals 130, 140 extend.

As shown, the core 110 is substantially cylindrical and elongated, defining an axis of the core 110. In other forms, the core 110 may have other configurations for example, the core 110 may have a polygonal cross-sectional shape (e.g., pentagonal, hexagonal). The core 110 extends substantially parallel to the bottom surface 135 of the electronic component 100 and/or mounting surface to which the electronic component is to be mounted (e.g., within 30 degrees). One benefit of including a core 110 that extends parallel to the circuit to which the electronic component 100 is mounted is that the height of the electronic component 100 may be minimized. For instance, the length of the core 110 may be increased without increasing the height of the electronic component 100. This may be advantageous in applications where the electronic component 100 must not exceed a certain height, yet the electronic component 100 requires a longer core 110 to achieve the desired performance specifications. For example, it allows a more powerful component to be provided in situations where height constraints are rigid by simply allowing for a longer core to be used so that a conductive coil with more turns may be provided, all while sticking within the height requirements. Obviously, this leads to a larger footprint being taken-up on the circuit board, so it will not be appropriate for all applications. Regardless, the horizontal orientation of the core (or generally parallel to the printed circuit board (PCB)) allows for a variety of windings to be used as the conductor (e.g., different lengths of wire, different sized of wire, differing number of turns of the wire wound coil, etc.). In a preferred form, the core will extend out beyond the conductor (or wire wound coil or winding) on each open-end of the coil to improve the performance of the component because the core contains more dense material than the outer mixture making up the outer body of the component which creates a more open magnetic field so current rating goes up or increases because the component simulates an open structure like a solenoid. In a preferred form, the core will only extend out beyond the open ends of the coil in an amount that is between (a) a smaller distance that is a little less than the width of the wire wound coil or coil winding and (b) a larger distance that is a little greater than the width of the coil winding.

In the embodiment shown in FIGS. 1A-1E, the conductor 150 is at least partially wound about an axis to form a winding 160. The core 110 may be positioned within the winding 160 of the conductor 150. In some forms, the conductor 150 is wound about core 110. The axis of the winding 160 extends horizontally or substantially parallel to the bottom surface 135 of the component 100 and/or the mounting surface similar to the axis of the core 110.

The conductor 150 may be a wire or other conductive component. The conductor 150 extends from a first end forming the first terminal 130 to a second end forming the second terminal 140 with the winding 160 formed on a portion of the conductor 150 therebetween. The first terminal 130 may be formed by bending the first end of the conductor 150 at bend 130A to extend substantially parallel to the bottom surface 135 of the electronic component 100 and/or mounting surface. The second terminal 140 likewise may be formed by bending the second end of the conductor 150 at bend 140A to extend substantially parallel to the bottom surface 135 of the electronic component 100 and/or mounting surface The wire of the conductor 150 may be a flat wire and have a thickness in the range of about 0.2 mm to about 0.6 mm, although a number of other shapes and thicknesses of the wire for the conductor 150 may be used. In one specific example, the wire has a thickness of about 0.4 mm. The conductor 150 may have a rectangular cross-section having wide opposing sides spaced apart by narrow opposing edges. In another example, the wire of the conductor 150 is a square wire having a substantially square cross-section. In yet other forms, the wire of the conductor 150 is a round wire having a substantially circular cross-section.

The winding 160 of the conductor 150 extends around more than 50% of the outer surface or circumference of the core 110. In one specific example, the winding 160 of conductor 150 extends around about 70% of the outer surface or circumference of the core before extending tangentially from the core 110 to the terminals 130, 140 (which again the terminals may be formed in a self-leaded fashion meaning from the winding itself and not necessarily a separate structure if desired). As shown in FIG. 1E, the conductor 150 may be substantially omega shaped (Ω-shaped) when viewed along the axis of the winding 160. This configuration allows a much thicker wire to be used so that the component can be used in high power applications, if desired. It also allows the component to offer an extremely low DCR (almost like an electrical short). The component may range in inductance from 5 nH-200 nH and in a preferred embodiment will be between 10 nH-100 nH. In one form, the component is provided in a 3 mm² package (generally rectangular but corners may be tapered or rounded if desired) producing an inductance of 12 nH. The component performance characteristics (or parameters) depend largely on the size of the component so the larger the component is the more inductance it can provide (e.g., more space for larger wire and/or more turns). By tapering in the legs of the conductor or coil below the core to form the ohm-shape (Ω-shape), the component increases the surface area of the conductor positioned proximate or adjacent to the core which allows the component to get better inductance performance because the core is more densely constructed than the surrounding outer body thereby improving the magnetic performance of the component.

In the embodiment shown in FIGS. 1A-1E, the component 100 includes an outer body 120. The outer body 120 preferably comprises a magnetic material, although a number of other conventional materials may be used. The outer body 120 covers at least a portion of the core 110 and conductor 150. In some forms, the ends of the core 110 may be exposed or extend through the outer body 120, as shown in FIG. 1A. In other forms, the outer body 120 covers or encases the core 120. The terminals 130, 140 may also remain exposed and extend through the outer body 120 enabling the component 100 to be mounted to a circuit via the terminals 130, 140. As shown in FIG. 1A, a bottom surface 132 and an end face 134 of terminal 130 may be exposed along both the bottom surface 135 and side wall of the component 100. Likewise, a bottom surface 142 and an end face 144 of terminal 140 may be exposed along both the bottom surface 135 and side wall of the component 100. Having the end faces 134, 144 of the terminals 130, 140 exposed may provide an increased surface area of the terminals 130, 140 available to electrically couple the electronic component 100 to a circuit. Having an increased surface area of the terminals 130, 140 may provide for a more robust connection between the electronic component 100 and the circuit. For instance, solder joining the electronic component 100 to the circuit may extend along the bottom surfaces 132, 142 and end faces 134, 144 of the terminals 130, 140 to better mechanically secure the electronic component 100 to the circuit and/or provide a better electrical connection therebetween. Having the end faces 134, 144 and bottom surfaces 132, 135 of the conductor exposed may also provide alternative surfaces for soldering to mount the electronic component 100. In some forms, the bottom surfaces 132, 135 of the conductor 150 are encased in the outer body 120 and the end faces 134, 144 exposed through the outer body 120 for mounting. In some forms, conductive plates are mounted to the electronic component 100 to form at least a portion of the terminals 130, 140. Conductive plates may extend along the end faces 134, 144 of the conductor 150, respectively, and form a surface that may be used to solder the electronic to a mounting surface. The conducive plates may provide an electrical and mechanical connection between the mounting surface (e.g., a circuit board) and the electronic component. In other forms, the end faces 134, 144 of the terminals 130, 140 may be covered or encased by the outer body 120.

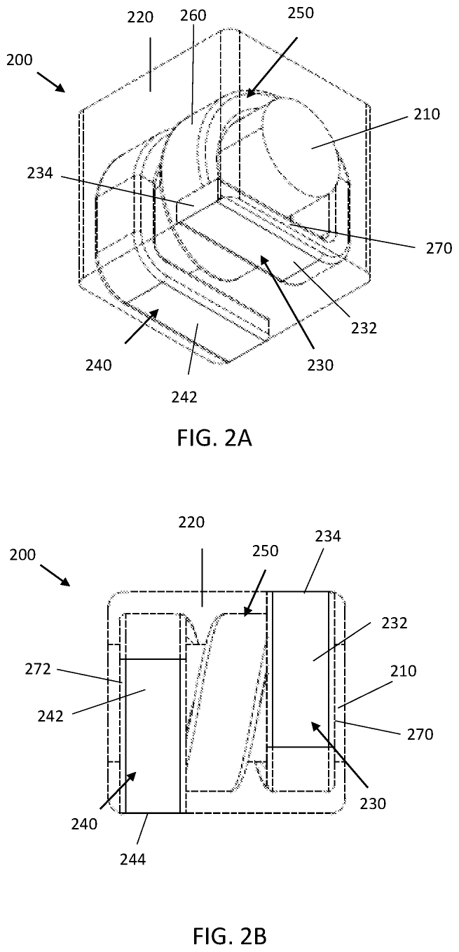

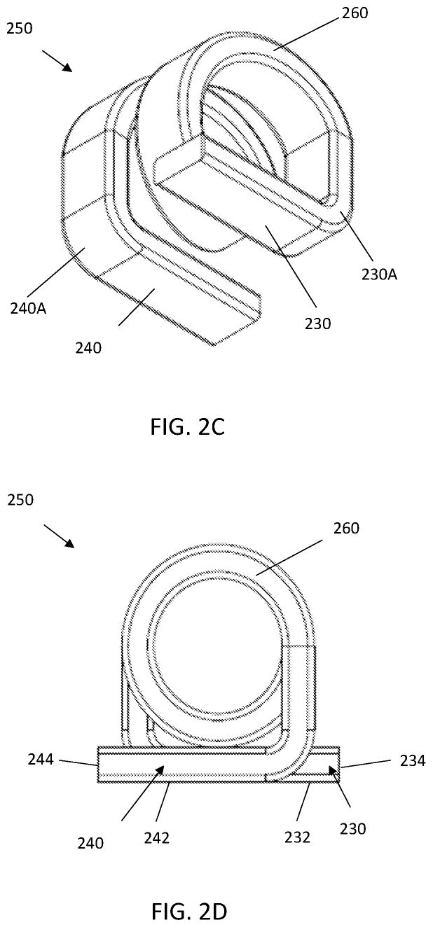

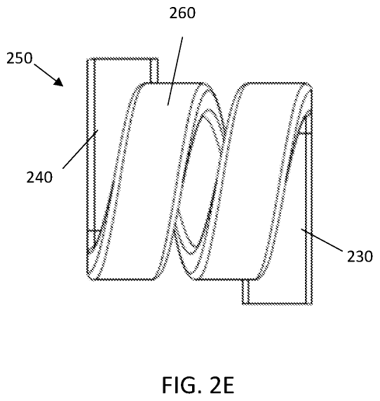

FIGS. 2A-5C show various alternative embodiments of the electronic component, with each of the various embodiments being similar in many respects to the electronic component shown and discussed with respect to FIGS. 1A-1E. For conciseness and clarity, the following discussion will highlight the differences of each of the following embodiments as compared to the first embodiment of the electronic component 100. For simplicity, the reference numerals used with regard to the first embodiment will be used to indicate features of the electronic component of the subsequent embodiments, with the prefix of the reference numerals changed to correspond to the embodiment being discussed. For instance, features of electronic component 200 of the second embodiment that correspond to features of the electronic component 100 are shown with the prefix of the reference numeral changed from “1” to “2.” For example, a feature shown as “110” with regard to the electronic component 100 will be shown as “210” with regard to the electronic component 200. Features of electronic component 300 of the third embodiment that correspond to features of the electronic component 100 are shown with the prefix of the reference numeral changed from “1” to “3” and so on.

Turning now to FIGS. 2A-2E, an electronic component 200 is illustrated in accordance with a second embodiment. The electronic component 200 is similar in many respects to the electronic component 100 of the first embodiment, the primary differences of which are highlighted in the following discussion.

Similar to the electronic component 100 of the first embodiment, the electronic component 200 includes an elongate core 210 and a conductor 250 having a winding 260 positioned about the core 210. The axis of the core 210 and the axis of the winding 260 extend horizontally or substantially parallel to a bottom surface 235 of the electronic component 200 and/or a mounting surface to which the first terminal 230 and the second terminal 240 are configured to be mounted to. A primary difference of the electronic component 200 of the second embodiment 200 is that the winding 260 of the conductor 250 is wound helically along an axis. In the embodiment shown, the winding 260 includes 1.5 turns. The turns of the winding 260 extend helically along the outer surface of the core 210 from the first terminal 230 to the second terminal 240. As with the first embodiment, the conductor 250 may be a flat wire having a thickness in the range of about 0.2 mm to about 0.6 mm, although a number of other shapes and thicknesses may be used. The conductor 250 may have a rectangular cross-section having wide opposing side-faces spaced apart by narrow opposing edge-faces. In another example, the wire of the conductor 250 is a square wire having a substantially square cross-section. In yet other forms, the wire of the conductor 250 is a round wire having a substantially circular cross-section.

The conductor 250 may be wound about the core 250 in an edge-face to edge-face configuration with a wide opposing side-face of the winding 260 of the conductor 250 facing inward toward the core 250. The performance characteristics of the component (or parameters) depend largely on the size of the component (e.g., large size allows for larger conductors to be used, more turns, etc.). In a preferred form, the component will provide an inductance range between 20 nH-1.5 μH. In one form a 3 mm² outer body size will be used with a single turn conductor yielding a 56 nH-330 nH inductance range. As will be discussed further herein, a two-turn conductor configuration may be provided that yields a little better than a 56 nH inductance, a three-turn conductor configuration may be provided that yields a 100 nH inductance, a four-turn conductor configuration may be provided that yields a 200 nH inductance, and a five-turn configuration may be provided that yields a 330 nH inductance.

The component 200 may include an outer body 220 disposed about at least a portion of the core 210 and the conductor 250. The first terminal 230 may be formed by a bend 230A in the conductor 250 at the first end of the winding 260 and the second terminal 240 may be formed by a bend 240A at the second end of the winding 260. The bottom surfaces 232, 242 of the first terminal 230 and the second terminal 240 of the conductor 250 extend substantially parallel to or within the same plane as the bottom surface 235 of the electronic component 200 such that the terminals 230, 240 extend parallel to the mounting surface to which the electronic component 200 is to be mounted. As with the first embodiment, the bottom surfaces 232, 242 and/or the end faces 234, 244 of the terminals 230, 240 may remain exposed through the outer body 220 for electrically coupling the electronic component 200 to a circuit. In some forms, the ends of the core 210 may remain exposed or extend through the outer body 220 whereas in other forms the ends of the core 210 may be covered by the outer body 220.

Additionally or alternatively, in some forms, the side faces 270, 272 of the conductor 250 remain exposed through the outer body 220 for electrically coupling the electronic component to a circuit at the sides of the electronic component 200. For example, the side faces 270, 272 may be exposed through the outer body 250 as they extend along the bottom of the electronic component 200 from the bends 230A, 240A to the end faces 234, 244. Exposing the side faces provides an alternative or additional surface to which the electronic component 200 may be soldered to a mounting surface.

In some forms, clips or conductive plates may be mounted to the sides of the electronic component 200 and electrically coupled to the ends of the windings to form a solderable surface for mounting the electronic component to a mounting surface. For example, a first conductive plate may be in electrical contact with and extend along at least a portion of the side faces 270 to form terminal 230 and a second conductive plate may be in electrical contact with and extend along at least a portion of the side face 272 to form terminal 240.

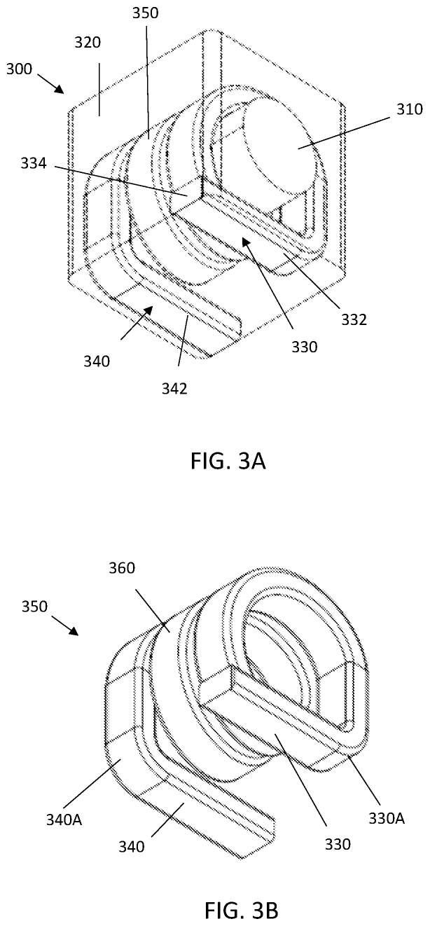

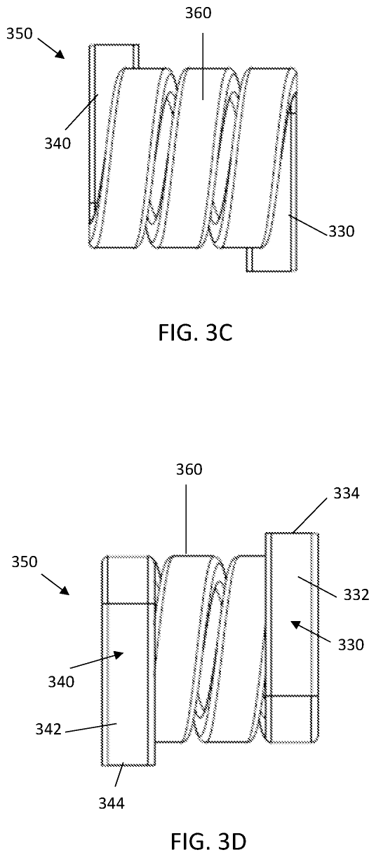

With reference to FIGS. 3A-3D, an electronic component 300 is shown according to a third embodiment. The electronic component 300 is similar to the electronic components of the previous embodiments, the primary differences of which are highlighted in the following discussion.

In the embodiment shown in FIGS. 3A-3D, the conductor 350 includes a winding 360 that includes turns helically wound around the core 310 along the axis of the core 310. As shown in FIGS. 3A-3D, the winding 360 of the conductor 350 of the electronic component 300 includes 2.5 turns. The conductor 350 may be a wire. The wire may be a flat wire that is wound edge-face to edge-face about the core 310. The flat wire may have a thickness similar to the embodiments above but have a width that is narrower than the width of the conductor 250 of the electronic component 200 such that the length of the electronic component 300 is not increased or not increased substantially with the increase in the number of turns in the winding. For instance, the electronic component 300 may be the same size as the electronic component 200 while including more turns in the winding 260. As an example, the width of the wire conductor used for a 3 mm² embodiment as discussed herein may utilize a wire that is 0.4 mm wide to 2.7 mm wide for the single turn ohm-shaped (Ω-shaped) conductor. In other embodiments it may range from 0.2 mm-1.5 mm thick and 0.3 mm-12 mm wide. In other forms, the electronic component 300 is larger than the previous embodiment and may include wire having the same width as the previous embodiments. In another example, the wire of the conductor 350 is a square wire having a substantially square cross-section. In yet other forms, the wire of the conductor 350 is a round wire having a substantially circular cross-section.

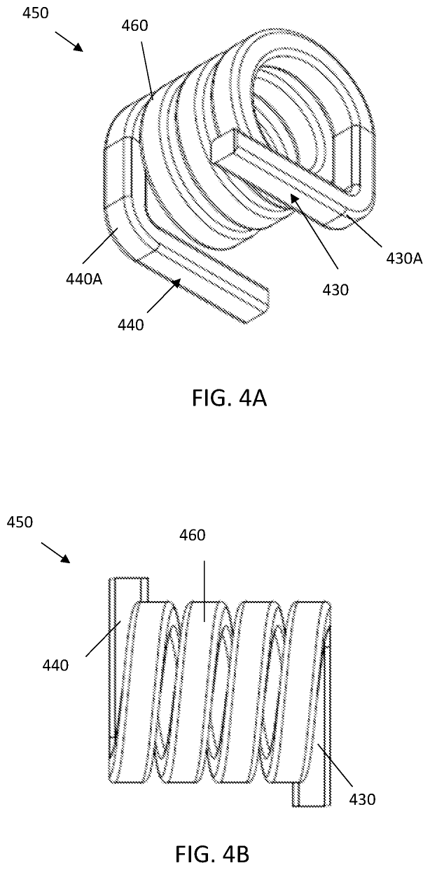

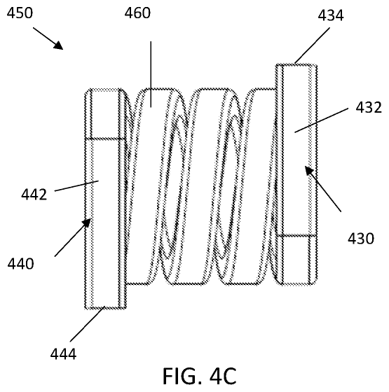

With reference to FIGS. 4A-4C, a conductor 450 according to another embodiment is shown for use with an electronic component similar to those described above. The conductor 450 includes a winding 460 that is helically wound about an axis such that the winding 460 may be positioned about a core of an electronic component. In the embodiment shown, the winding 460 of the conductor 450 includes 3.5 turns. As with the conductor 350 of the third embodiment, the conductor 450 may be formed of a flat wire. The thickness of the flat wire may be similar to that of the previous embodiments. The width of the flat wire may be narrower than that of the conductor 350 to reduce the increase in length of the electronic component including the conductor 450 while including additional turns in the winding 460 of the conductor 450. For instance, the length of the winding 460 may be the same as length of the winding 360 of the electronic component 300 while including an additional turn due to the narrower width of the wire. The width and thickness of the wire may vary as discussed herein above. In another example, the wire of the conductor 450 is a square wire having a substantially square cross-section. In yet other forms, the wire of the conductor 450 is a round wire having a substantially circular cross-section.

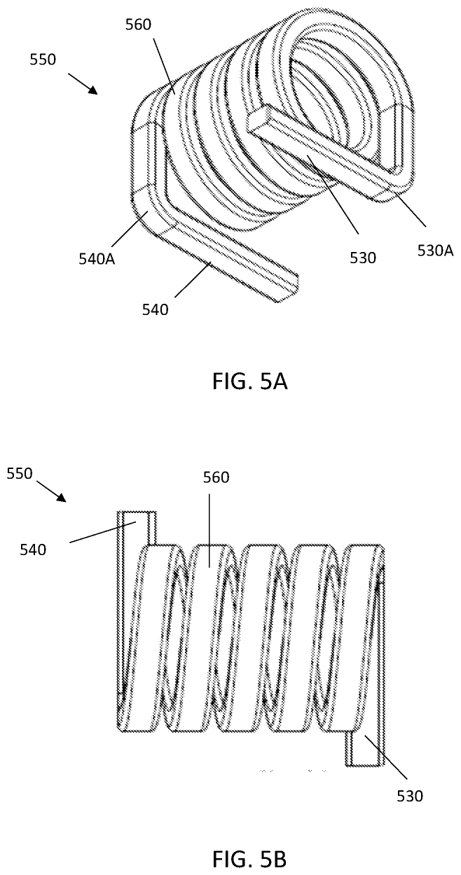

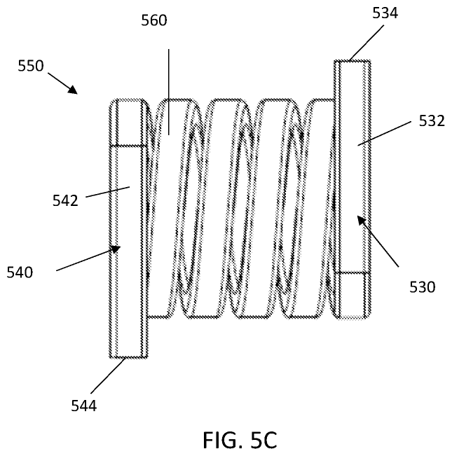

With reference to FIGS. 5A-5C, yet another conductor 550 according to another embodiment is shown for use with an electronic component similar to those described above. The winding 560 of the conductor 550 may include 4.5 turns. The conductor 550 may be formed of a flat wire having a narrower width to reduce the axial length of the winding 560 while including an more turns. For instance, the length of the winding 560 may be the same as length of the winding 360 of the electronic component 300 while including two additional turns. The width and thickness of the wire may vary within the range discussed herein above. In another example, the wire of the conductor 550 is a square wire having a substantially square cross-section. In yet other forms, the wire of the conductor 550 is a round wire having a substantially circular cross-section.

In other embodiments, a conductor may be wound to include six or more windings. The conductor may be positioned about a core similar to the previously described embodiments. In some forms, the conductor may have a smaller wire size (e.g., width and/or thickness) for each additional winding. For example, the size of the wire may be decreased such that the overall axial length of the winding of the conductor, and thus the overall size of the electronic component, does not increase with the increase in additional turns. This may permit an electronic component to have additional turns to achieve different performance specifications while maintaining the footprint of the electronic component on a circuit board.

In each of the above-described embodiments, the core 110 and the conductor 150 comprise an assembly. While the following discussion refers to the electronic component 100 of the first embodiment, it should be understood that the following discussion also applies to each of the above-described embodiments is not limited to only the first embodiment. The conductor 150 may be wound to form the winding 160. In some forms, the conductor 150 is wound about the core 110. In other forms, the conductor is wound about an axis and the core 110 is positioned within the winding 160. Once assembled, the assembly is encased or embedded in the outer body 120. By one approach, the outer body 120 comprises a mixture of magnetic and/or non-magnetic powder that can be potted and cured, injection molded (which includes transfer molded or wet-press compression molded as discussed herein), or dry-press compression molded. For example, in one embodiment, the mixture that makes up outer body 120 includes a powdered iron or iron alloy, such as Carbonyl Iron powder, and a polymer binder, such as a plastic solution, which are compression molded over the core 110 and the conductor 150. In a preferred form, the ratio of powdered iron or iron alloy to binder is about 10% to 98% powdered iron or iron alloy to about 2% to 90% binder, by weight. In the embodiments illustrated, the ratio of powdered iron to binder will be about 80% to 92% powder iron or iron alloy to about 8% to 20% polymer resin, by weight. As with the compression molded component, the potted component may alternatively use powdered ferrite or a mixture of powdered ferrite and another powdered iron or iron alloy. In other forms, other types of powdered iron or iron alloys may be used and/or composite materials may be used, if desired. Some common materials used for the powdered iron include amorphous alloy powders, carbonyl iron powder, nylon coated barium ferrite powders, barium ferrite powders, iron powders, steel powders (e.g., Anchor, Ancormet, Ancorsteel), magnetic ceramic powders (e.g., Ceramag), as well as other equivalent materials and mixtures. In some forms, materials may be at least one material selected from the group consisting of carbonyl iron powders, ferrite powders, barium ferrite powders, iron powders, steel powders, permalloy powder, sendust powder, magnetic ceramic powders, iron alloys, as well as mixtures thereof. The binder may be any conventional binder, e.g., any epoxy binders including epoxy powder, phenol (phenolic) resins, silicone resins, acrylic resins, or other binders, such as hot melt adhesives of one or more materials from the group comprising thermoplastic resins, thermosetting resins (thermal set), polyvinyl alcohol (PVA) binder, polyvinyl butyral (PVB) binder, hot melt adhesives, or other similar binders as well as mixtures thereof.

It is possible and even desirable in some low current, high inductance applications for the molded mixture of the outer body 120 to further include powdered ferrite and, depending on the application, the powdered ferrite may actually replace the powdered iron in its entirety. For example, a ferrite powder with a higher permeability may be added to the mixture to further improve the performance of the component 100. The above ratios of powdered iron are also applicable when a combination of ferrite and powdered iron is used in the mixture and when powdered ferrite is used alone in the mixture. In yet other embodiments, other types of powdered metals may be used in addition to or in place of those materials discussed above.

After compression molding the mixture, the mold may be removed from a molding machine and the component 100 may be ground to the desired size (if needed). The component 100 is then removed from the mold and stored in conventional tape and reel packaging or other conventional packaging for use with existing pick-and-place machines in industry. A lubricant such as Teflon or zinc stearate may also be used in connection with the mold in order to make it easier to remove the component 100, if desired.

Alternatively, the component 100 may be made by potting and curing the mixture that makes up the outer body 120, rather than compression molding the component 100. The main advantages to potting and curing are that the component 100 can be manufactured quicker and cheaper than the above-described compression molding process will allow. In this embodiment, the mixture that makes up outer body 120 may similarly be made of magnetic and/or non-magnetic material and will preferably include a powdered iron, such as Carbonyl Iron powder, and a binder, such as epoxy, which is potted and cured over the core 110 and conductor 150. In this embodiment, the ratio of powdered iron or iron alloy to binder is about 10% to 98% powdered iron or iron alloy to 2% to 90% binder, by weight, with a preferred ratio of powdered iron or iron alloy to binder being about 70% to 90% powder iron or iron alloy to about 10% to 30% epoxy, by weight. As with the compression molded component 100, the potted component 100 may alternatively use powdered ferrite or a mixture of powdered ferrite and another powdered iron. In other forms, other types of powdered iron or iron alloys may be used and/or composite materials may be used, if desired. Regardless of whether the component is potted and cured, injection molded (including for example transfer molding or wet compression molding of a liquid or slurry of mixtures), or dry compression molded, the ratio of binder (e.g., epoxy, resin, etc.) to magnetic and/or non-magnetic material (e.g., powdered iron, powdered ferrite, etc.) impacts the inductance and current handling capabilities of the electronic component.

In this configuration, the assembled core 110 and conductor 150 will preferably be inserted into a recess that contains the mixture making up the outer body 120 and an adhesive such as glue. The mixture and assembly are then cured to produce a finished component 100. As with the first embodiment discussed above, the cured component 100 may also be ground to a specific size (if desired) and then packaged into convention tape and reel packaging for use with existing pick-and-place equipment.

Regardless of whether the component 100 is potted and cured, injection molded (which may include transfer molded or wet-press compression molded using a liquified or slurry mixture to inject about the core and conductor), or dry-press compression molded, the ratio of binder (e.g., epoxy, resin, etc.) to magnetic and/or non-magnetic material (e.g., powdered iron, powdered ferrite, etc.) impacts the inductance and current handling capabilities of the electronic component 100. For example, increasing the amount of epoxy or resin and lowering the amount of powdered iron produces a component 100 capable of handling higher current but having lower inductance capabilities. Therefore, changing the ratio of the substances relative to one another produces different components 100 with different capabilities and weaknesses. Such options allow the component 100 to be customized for specific applications. More particularly, customizing the electronic component 100 allows the component 100 to be precisely tailored to the particular chosen application. Different applications have different requirements such as component size, inductance capabilities, current capacity, limits on cost, etc. Customization can include choosing a wire gauge and length relative to the amount of current and/or inductance required for the application. For example, higher inductance applications may require an increased number of coil turns, and/or a wire with a relatively large cross-sectional area (i.e., gauge).

In addition, customization can include selecting the material that comprises the core 110, along with the dimensions, and structural specifications for the core 110. For example, a ferrite with higher permeability or higher dielectric constants may be chosen to increase inductance. By varying the ratio of elements that comprise the ferrite the grade of the ferrite changes and different grades are suited for different applications.

While many of these variables can alter various specifications of the electronic components, many of them can also create constraints on other variables. For example, increasing the number of turns of the conductor 150, as shown in the embodiments above, may limit the size of the core 110 that can be used if a specific component length must be reached. Similarly, increasing the number of turns of the conductor 150 may limit the size of the wire that may be used to achieve an electronic component having desired dimensions and performance capabilities. Therefore, application requirements and material limitations must be considered when choosing the core 110 material and other specifications.

In addition to choosing the core 110, the components of the mixture that makes up outer body 120 must also be selected. The mixture typically includes a powder metal iron such as ferrite or Carbonyl Iron powder and either resin or epoxy. The application and manufacturing constraints determine which components to include in the mixture. In low current, high inductance applications, it may be more desirable to increase the percentage of ferrite used in the mixture making up body 120. Conversely, in high current, low inductance applications, it may be more desirable to limit the percentage of ferrite (if any) used in the mixture making up body 120.

It is well known in the art to use a dry mold or dry press process to form a magnetic mixture around a wire coil, thereby creating a green body which can be further heated (i.e., a secondary heating) to form the electrical component 100. Such processes often require significant forces that can damage or destroy certain types, configurations, or gauges of wire. An electrical component 100 that has been damaged via such processes may short or otherwise fail. Further, the type and extent of damage that may occur during such processes can vary depending on the placement, direction, or magnitude of the compression forces involved, making this problem difficult to detect and address, and possibly resulting it some components 100 passing internal tests only to fail after shipment.

In order to avoid such shortcomings, the core 110 may be used to help retain and/or protect the configuration of the conductor 150 and help it withstand the various forces and pressures it may be subjected to during manufacture. Furthermore, instead of employing a dry press process to mold the mixture around the wire, the mixture making up outer body 120 may be heated to a liquid that can then be dispersed (e.g., injected or disposed) over at least a portion of the conductor 150 to avoid exposing the conductor 150 to the damaging forces of a dry press process. For example, in one form, the mixture may be liquefied and dispersed over the conductor 150 and the core 110 via an injection molding, compression molding or other molding process, and then hardened to form outer body 120. After the liquid mixture has been formed into the outer body 120, the component 100 may be removed from the mold.

By a further embodiment, the outer body 120 may be a pre-formed cap or case that may be composed of any of the various combinations of materials discussed above or may be composed of formed sheet metal or cast metal, such as aluminum, steel, copper, or the like. The pre-formed outer body 120 is then attached to the first terminal 130 and second terminal 140 and/or the ends of the core 110 by conventional means to form an encased, or overmolded, component 100.

By a further embodiment, the outer body 120 may be a pre-formed cap or case that may be composed of any of the various combinations of materials discussed above or may be composed of formed sheet metal or cast metal, such as aluminum, steel, copper, or the like. The pre-formed outer body 120 is then attached to the first terminal 130 and second terminal 140 by conventional means with the ends of the core 110 exposed at each end of the component 100.

By creating an inductor according to these teachings, the inductor is well suited for use in power applications, such as battery power application, and more particularly in applications where the input is higher than the output. The component is suitable for use for any magnetic applications (e.g., transformer, inductors, etc.), but preferably will be used in any number of inductor applications (e.g., power inductors, chokes, RF applications, filters, DC-DC converters, etc.).

Although a flat wire embodiment is described throughout this disclosure, other wire forms may be suitable for use in the electronic component 100, including standard round wire, thin films, or other conductors. For example, these teachings can readily be utilized with eighteen gauge to forty-two gauge (18 AWG-42 AWG) round or flat wire, though wire of larger or smaller gauges can be utilized equally as well dependent upon the specifics of the application. In a preferred form, the range will be 28 AWG-42 AWG). In practice, the specific application and height of the component 100 will often factor into what wire gauge is selected. Similarly, as the preferred later embodiments (e.g., FIGS. 2A on) show the component configured in a self-leaded configuration (e.g., where the ends of the conductor are used to actually serve as the terminals), it should be understood that in alternate forms, the component may be configured such that additional clips are added to the component and bonded to the conductor ends (e.g., such as by solder) such that the clips actually serve as the component terminals for connecting the component to a circuit on a printed circuit board (PCB). In still other forms, the terminals may be formed on the component via metalization or a deposition process where the metalized or deposition surface serves as the terminal along with the respective conductor end connected thereto via solder or the like. The terminals illustrated in FIGS. 1A may either be clips or metalized pads added that make conductive engagement with the conductor ends so that the component may be soldered to a circuit on a printed circuit board (PCB) by taking advantage of the larger surface area the pads (130, 140) provide (e.g., provides larger surface area to bond the component to the PCB and/or larger surface area for a soldering iron or the like to engage to solder the component to the PCB.

Furthermore, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. An electronic component comprising:
a core defining an axis;
a conductor at least partially wound about the core; and
a mounting surface defining a plane and configured to engage a board surface, the axis of the core extending substantially parallel to the plane.

2. The electronic component of claim 1 further comprising a first terminal and a second terminal extending along the plane of the mounting surface.

3. The electronic component of claim 2 wherein a first end of the conductor is the first terminal and a second end of the conductor is the second terminal for mounting to the board surface.

4. The electronic component of claim 2 wherein an end face of the first terminal and an end face of the second terminal are exposed through opposing sides of an outer body encapsulating at least a portion of the core and the conductor.

5. The electronic component of claim 1 wherein the conductor is a flat wire.

6. The electronic component of claim 1 wherein the conductor is a round wire.

7. The electronic component of claim 1 wherein the conductor is only partially wound about the core.

8. The electronic component of claim 7 wherein the conductor is wound along about 50% to 90% of an outer diameter of the core.

9. The electronic component of claim 8 wherein the conductor is substantially Ω-shaped.

10. The electronic component of claim 1 wherein the conductor is helically wound about the core along the axis of the core.

11. The electronic component of claim 1 wherein the conductor is wound about the core to form a plurality of turns about the core.

12. The electronic component of claim 11 wherein the conductor is a flat wire having a cross section with opposing sides spaced apart by opposing edges, wherein each side of the cross section represents a side-face of the flat wire, and each edge of the cross section represents an edge-face, and wherein the plurality of turns are wound edge-face to edge-face.

13. The electronic component of claim 1 wherein the core is elongate and substantially cylindrical.

14. The electronic component of claim 1 further comprising a magnetic and/or non-magnetic material forming an encapsulating body about at least a portion of the core and the conductor.

15. The electronic component of claim 14 wherein an end of the core is exposed through the encapsulating body.

16. The electronic component of claim 1 further comprising a first terminal and a second terminal, the first terminal including a first conductive plate extending along a first end of the conductor, the second terminal including a second conductive plate extending along a second end of the conductor.

17. The electronic component of claim 16 wherein a portion of the first conductive plate and a portion of the second conductive plate extend transversely to the axis of the core.

18. The electronic component of claim 17 wherein the portion of the first conductive plate and the portion of the second conductive plate extend on a same side of the core.

19-27. (canceled)

28. A circuit comprising:
a board having a planar portion; and
an electronic component attached to the board, the electronic component comprising:
a mounting surface defining a plane extending substantially parallel to the planar portion of the board;
a conductor at least partially wound about an axis, the axis extending substantially parallel to the plane of the mounting surface.

29. The circuit of claim 28 wherein the conductor has a first end portion and a second end portion that extend substantially parallel to the planar portion of the board.

30. The circuit of claim 28 wherein the electronic component further comprises a core extending along the axis, the conductor at least partially wound about the core.

31. The circuit of claim 28 wherein the electronic component further comprises a first terminal and a second terminal electrically connected to the planar portion of the board.

32. The circuit of claim 31 wherein the first terminal includes a first end portion of the conductor and the second terminal includes a second end portion of the conductor.

33. The circuit of claim 31 wherein the first terminal is soldered to a second conductor of the planar portion of the board and the second terminal is soldered to a third conductor of the planar portion of the board.

34. The circuit of claim 28 wherein the electronic component includes a magnetic and/or non-magnetic material forming an encapsulating body about at least a portion of the conductor, the encapsulating body forming at least a portion of the mounting surface.

35. The circuit of claim 34 wherein the encapsulating body forms one or more side surfaces extending from the mounting surface, a first end portion of the conductor and a second end portion of the conductor exposed through the mounting surface and the one or more side surfaces of the encapsulating body.

36. An electronic component comprising:
a core defining an axis; and
a conductor at least partially wound about the core to from a conductor winding,
the conductor having a first terminal end and a second terminal end, the first terminal end being at a first end of the conductor winding, the second terminal end being at a second end of the conductor winding, the core having a first half about the axis a second half about the axis, and the first terminal end and the second terminal end being along the second half of the core.

37. The electronic component of claim 36 wherein the first terminal end and the second terminal end reside in a same plane.

38. The electronic component of claim 37 wherein the same plane is substantially parallel to the axis.

39. The electronic component of claim 38 wherein the first terminal end includes a first planar mounting surface and the second terminal end includes a second planar mounting surface extending along the same plane.

40. The electronic component of claim 38 wherein a portion of the first terminal end extends tangentially from the conductor winding toward the first planar mounting surface and a portion of the second terminal end extends tangentially from the conductor winding toward the second planar mounting surface.

41. The electronic component of claim 36 further comprising a first terminal and a second terminal, wherein at least a portion of the first terminal end forms or connects to the first terminal and at least a portion of the second terminal end forms or connects to the second terminal.

42. The electronic component of claim 36 further comprising a magnetic and/or non-magnetic material forming an encapsulating body about at least a portion of the conductor, the encapsulating body forming at least a portion of a planar mounting surface along which the first terminal end and the second terminal end extend.
